(19) United States
(12) Patent Application Publication
(10) Pub. No.: US 2024/0216735 A1
(43) Pub. Date: Jul. 4, 2024

(54) Fire Extinguishing Device Having Fire Extinguishing Agent And Fire Extinguishing Capsule

(71) Applicant: FIREKIM Energy Solution CO., Ltd, Chungcheongbuk-do (KR)

(72) Inventor: Byung Yul KIM, Chungcheongbuk-do (KR)

(73) Assignee: FIREKIM Energy Solution CO., Ltd, Chungcheongbuk-do (KR)

(21) Appl. No.: 18/390,284

(22) Filed: Dec. 20, 2023

(30) Foreign Application Priority Data
Dec. 30, 2022 (KR) 10-2022-0190962
Dec. 30, 2022 (KR) 10-2022-0190978

(51) Int. Cl. A62C 35/10; A62C 3/16

(52) U.S. Cl. CPC A62C 35/10; A62C 3/16

(57) ABSTRACT

A fire extinguishing device having a fire extinguishing agent and a fire extinguishing capsule is provided. The fire extinguishing device includes a base portion having an internal space in a form of a capsule and a fire extinguishing agent located inside the base portion and configured to extinguish a flame, wherein the base portion is formed to be in contact with a target object, the fire extinguishing agent vaporizes at a determined temperature or higher according to heat generation or ignition of the base portion, a contact area between the base portion and the target object increases as the base portion expands, and the base portion is configured to, in a case of a fire or explosion of the target object, be destroyed together and the fire extinguishing agent is dispersed in a direction of the target object.

### CROSS-REFERENCE TO RELATED APPLICATION

This application claims the benefit of Korean Patent Application Nos. 10-2022-0190962 filed on Dec. 30, 2022 and 10-2022-0190978 filed on Dec. 30, 2022, in the Korean Intellectual Property Office, the entire disclosures of which are incorporated herein by reference for all purposes.

### BACKGROUND

### 1. Field of the Invention

One or more embodiments relate to a fire extinguishing device having a fire extinguishing agent and a fire extinguishing capsule, and more particularly, to a fire extinguishing device having a fire extinguishing agent that may be sprayed to a fire area in the event of a fire to extinguish the fire and a fire extinguishing capsule that may spray the fire extinguishing agent.

### 2. Description of the Related Art

As the demand for a portable electronic product such as a laptop, video camera, and portable phone is rapidly increasing and the development of an electric vehicle, energy storage battery, robot, and satellite is in active progress, research on a high-performance rechargeable battery is being actively conducted.

When a battery overheats due to its usage environment or its own aging, the battery explodes and causes a fire. Various cooling structures and cooling methods exist to suppress overheating of the battery. However, even using existing cooling structures and cooling methods, it is impossible to completely prevent a fire due to overheating of the battery.

Accordingly, there is a demand for the development of a device that can quickly extinguish a fire in the event of a battery fire.

In the case of a lithium-ion battery, which has been used most frequently in recent years, it has been confirmed that hydrofluoric acid is leaked, which can pose a fatal risk to the human body, in the event of a fire.

Specifically, a lithium-ion battery generally contains an electrolyte, lithium hexafluorophosphate (LiPF₆), which hydrolyzes at about 70 degrees Celsius to generate hydrofluoric acid gas.

More specifically, lithium hexafluorophosphate reacts with water present in the air or water supplied for extinguishing a fire in abnormal environments (e.g., a fire, shock, thermal runaway, etc.) and releases hydrofluoric acid gas.

Hydrofluoric acid gas is a colorless gas, highly flammable and irritating, and is non-flammable and thus does not burn or explode. In addition, hydrofluoric acid gas does not disappear naturally, has a small molecular weight and thus a fast diffusion rate, and damages the nervous system when exposed to the human body and causes no pain, which may worsen damage to the human body. When exposed to a high concentration of hydrofluoric acid gas, fatal effects may be caused on the lungs and heart, resulting in sudden death, and calcium in the bones and the dermal layer may be destroyed.

Therefore, there is a need to develop a fire extinguishing device to reduce damage from hydrofluoric acid caused by lithium-ion battery fires.

The above description has been possessed or acquired by the inventor(s) in the course of conceiving the present disclosure and is not necessarily an art publicly known before the present application is filed.

### SUMMARY

Embodiments provide a fire extinguishing device having a fire extinguishing agent and a fire extinguishing capsule that may neutralize hydrofluoric acid gas generated in the event of a battery fire.

Embodiments provide a fire extinguishing device having a fire extinguishing agent and a fire extinguishing capsule that may quickly extinguish a battery fire.

Embodiments provide a fire extinguishing device having a fire extinguishing agent and a fire extinguishing capsule that may be easily installed.

Embodiments provide a fire extinguishing device having a fire extinguishing agent and a fire extinguishing capsule that may automatically extinguish a battery fire.

Embodiments provide a fire extinguishing device having a fire extinguishing agent and a fire extinguishing capsule that may prevent hydrofluoric acid gas from spreading into the air by quickly dispersing a neutralizing agent.

Embodiments provide a fire extinguishing device having a fire extinguishing agent and a fire extinguishing capsule, in which the fire extinguishing capsule expands and seals a battery in the event of a battery fire and accordingly blocks the battery from the air.

Embodiments provide a fire extinguishing device having a fire extinguishing agent and a fire extinguishing capsule, in which the fire extinguishing capsule expands, blocks a space between a battery and the fire extinguishing device, and accordingly is destroyed to cause the fire extinguishing agent to be intensively supplied to the battery and not discharged to the outside.

Embodiments provide a fire extinguishing device having a fire extinguishing agent and a fire extinguishing capsule, in which a space is formed between the fire extinguishing capsule and a battery to provide a space for cooling fluid to flow.

Embodiments provide a fire extinguishing device having a fire extinguishing agent and a fire extinguishing capsule that is flexible enough to be installed on batteries of various shapes.

Embodiments provide a fire extinguishing device having a fire extinguishing agent and a fire extinguishing capsule that may improve a sealing property by simultaneously expanding all fire extinguishing capsules in the event of ignition of a battery.

According to an aspect, there is provided a fire extinguishing device having a fire extinguishing agent and a fire extinguishing capsule including a base portion having an internal space in a form of a capsule and a fire extinguishing agent located inside the base portion and configured to extinguish a flame, wherein the base portion is formed to be in contact with a target object, the fire extinguishing agent vaporizes at a determined temperature or higher according to heat generation or ignition of the base portion, the base portion is formed by mixing polymer and silicone or comprises a polymer layer and a silicone layer configured to coat an outer surface of the polymer layer, and is configured to expand and rupture at the determined temperature due to vaporization of the fire extinguishing agent, a contact area between the base portion and the target object increases as the base portion expands, and the base portion is configured to, in a case of afire or explosion of the target object, be destroyed together and the fire extinguishing agent is dispersed in a direction of the target object.

The base portion may be formed in a cylindrical shape, pouch shape, pad shape, or tape shape and may include a plurality of capsules and a skirt extending flat from the capsules and connecting the capsules. The base portion may be formed in a plane film shape so that the plurality of capsules is arranged in a plane, and configured to, when the target object reaches the determined temperature or higher due to external ignition or heat generation, expand due to the fire extinguishing agent and block the target object from air.

The capsules may protrude from the skirt that may be formed flat so that the capsules may be in contact with the target object, the skirt may be placed to be spaced apart from the target object, and a space may be formed between the target object and the skirt.

A determined expansion space may be formed inside the skirt and the fire extinguishing agent, an expansion agent, or an additional fire extinguishing agent that vaporizes or expands at the determined temperature may be provided in the expansion space. Alternatively, an inside of the capsules may be formed as a plurality of partitioned hollow portions and the fire extinguishing agent, the expansion agent, or the additional fire extinguishing agent may be separately provided in each of the partitioned hollow portions. When the capsules or the skirt reaches the determined temperature due to ignition or heat generation of the target object, the fire extinguishing agent, the expansion agent, or the additional fire extinguishing agent may vaporize or expand and, accordingly, the capsules or the skirt may expand to be in contact with the target object.

The base portion may include a trigger member configured to promote vaporization of the fire extinguishing agent, and the trigger member may be configured to, in a case of the ignition or heat generation of the target object, expand the capsules simultaneously at the determined temperature or higher.

According to another aspect, there is provided a fire extinguishing device having a fire extinguishing agent and a fire extinguishing capsule including a base portion, which includes a space inside, and a fire extinguishing agent, wherein the fire extinguishing agent includes a fire extinguishing substance configured to extinguish a target object in a case of ignition of the target object and a neutralizing substance configured to neutralize acid gas generated due to the ignition of the target object.

The base portion may include a partitioned space inside, the fire extinguishing substance may be provided in the partitioned space inside the base portion, and the neutralizing substance may be provided in the partitioned space inside the base portion separately from the fire extinguishing substance. The fire extinguishing substance may vaporize in the case of the ignition of the target object, the partitioned space inside the base portion in which the fire extinguishing substance may be provided may expand and be destroyed due to vaporization pressure of the fire extinguishing substance, the partitioned space inside the base portion in which the neutralizing substance is provided may be destroyed together with the partitioned space inside the base portion in which the fire extinguishing substance is provided, and the fire extinguishing substance and the neutralizing substance may be simultaneously dispersed. The neutralizing substance may include an alkaline component or a calcium compound component.

The fire extinguishing device having a fire extinguishing agent and a fire extinguishing capsule may further include a fracture portion, an ignition detection portion, and a controller, wherein the fracture portion may be configured to destroy the base portion at a determined temperature or in a case of a flame, the ignition detection portion may be configured to detect the ignition of the target object and transmit an ignition signal to the controller, the controller may be configured to transmit a base portion destruction signal to the fracture portion, and the fracture portion may be configured to destroy the base portion to disperse the fire extinguishing agent to the target object.

Additional aspects of embodiments will be set forth in part in the description which follows and, in part, will be apparent from the description, or may be learned by practice of the disclosure.

The effects of the present disclosure obtained through the technical solutions described above are as follows.

According to embodiments, there may be provided a fire extinguishing device having a fire extinguishing agent and a fire extinguishing capsule that may neutralize hydrofluoric acid gas generated in the event of a battery fire.

According to embodiments, there may be provided a fire extinguishing device having a fire extinguishing agent and a fire extinguishing capsule that may quickly extinguish a battery fire.

According to embodiments, there may be provided a fire extinguishing device having a fire extinguishing agent and a fire extinguishing capsule that may be easily installed.

According to embodiments, there may be provided a fire extinguishing device having a fire extinguishing agent and a fire extinguishing capsule that may automatically extinguish a battery fire.

According to embodiments, there may be provided a fire extinguishing device having a fire extinguishing agent and a fire extinguishing capsule that may prevent hydrofluoric acid gas from spreading into the air by quickly dispersing a neutralizing agent.

According to embodiments, there may be provided a fire extinguishing device having a fire extinguishing agent and a fire extinguishing capsule, in which the fire extinguishing capsule expands and seals a battery in the event of a battery fire and accordingly blocks the battery from the air.

According to embodiments, there may be provided a fire extinguishing device having a fire extinguishing agent and a fire extinguishing capsule, in which the fire extinguishing capsule expands, blocks a space between a battery and the fire extinguishing device, and accordingly is destroyed to cause the fire extinguishing agent to be intensively supplied to the battery and not discharged to the outside.

According to embodiments, there may be provided a fire extinguishing device having a fire extinguishing agent and a fire extinguishing capsule, in which a space is formed between the fire extinguishing capsule and a battery to provide a space for cooling fluid to flow.

According to embodiments, there may be provided a fire extinguishing device having a fire extinguishing agent and a fire extinguishing capsule that is flexible enough to be installed on batteries of various shapes.

According to embodiments, there may be provided a fire extinguishing device having a fire extinguishing agent and a fire extinguishing capsule that may improve a sealing property by simultaneously expanding all fire extinguishing capsules in the event of ignition of a battery.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a perspective view of a fire extinguishing device having a fire extinguishing agent and a fire extinguishing capsule formed in a film shape, according to an embodiment;

FIG. 2 is a perspective view of a fire extinguishing device having a fire extinguishing agent and a fire extinguishing capsule that is formed in a pouch shape to include a target object inside, according to an embodiment;

FIGS. 3A to 3C are cross-sectional views of a capsule and skirt portions of a fire extinguishing device having a fire extinguishing agent and a fire extinguishing capsule, according to an embodiment; and

FIGS. 4A to 4C are diagrams illustrating changes in a fire extinguishing device having a fire extinguishing agent and a fire extinguishing capsule due to ignition or heat generation of a battery.

### DETAILED DESCRIPTION

Hereinafter, afire extinguishing device having a fire extinguishing agent and a fire extinguishing capsule is described in detail with reference to the drawings. The attached drawings are provided only to help understand the embodiments disclosed in this specification, and the technical idea disclosed in this specification is not limited by the drawings. The embodiments should be understood to include all changes, equivalents, and replacements within the idea and the technical scope of the present disclosure.

The singular forms “a,” “an,” and “the” are intended to include the plural forms as well, unless the context clearly indicates otherwise.

It should be noted that if one component is described as being “connected,” “coupled,” or “joined” to another component, the first component may be directly connected, coupled, or joined to the second component, or a third component may be “connected,” “coupled,” or “joined” between the first and second components. On the contrary, it should be noted that if it is described that one component is “directly connected,” “directly coupled,” or “directly joined” to another component, a third component may be absent.

It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

In addition, terms such as first, second, A, B, (a), (b), and the like may be used herein to describe components. These terms are used only for the purpose of discriminating one component from another component, and the nature, the sequences, the orders, or the like of the components are not limited by the terms. It is to be understood that if a component is described as being “connected,” “coupled,” or “joined” to another component, the former may be directly “connected,” “coupled,” or “joined” to the latter or “connected,” “coupled,” or “joined” to the latter via another component.

The same name may be used to describe components having a common function in different embodiments. Unless otherwise mentioned, the description of one example may be applicable to another example. Thus, duplicated description is omitted for conciseness.

In addition, components with reference numerals of the same structure may be recognized as the same or similar components in other embodiments unless otherwise specified. For example, a component 1320 or a component with a reference numeral of a similar structure may be the same as or similar to components 320, 2320, 3320, and the like, unless otherwise specified.

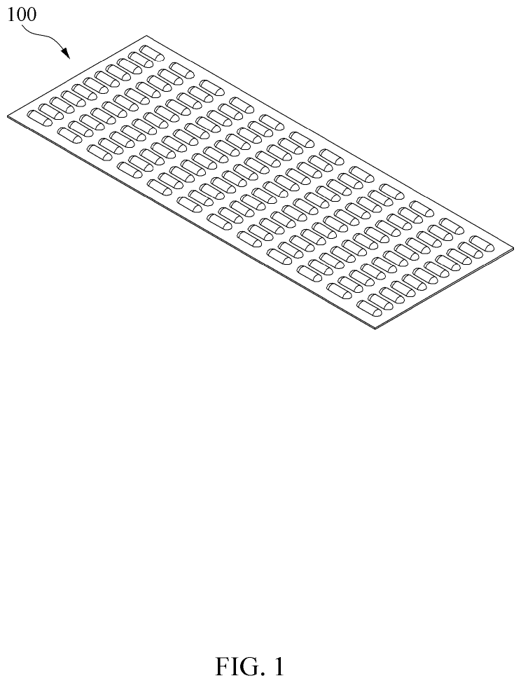

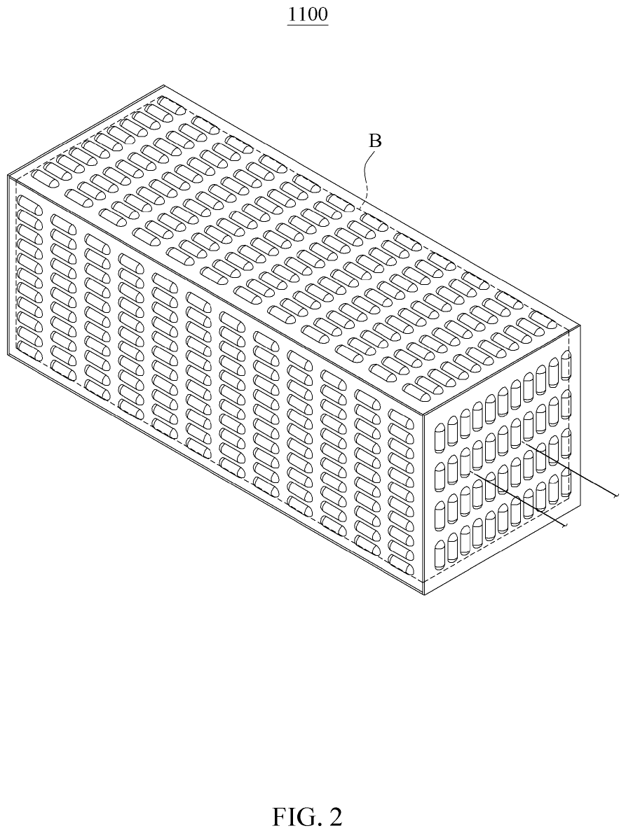

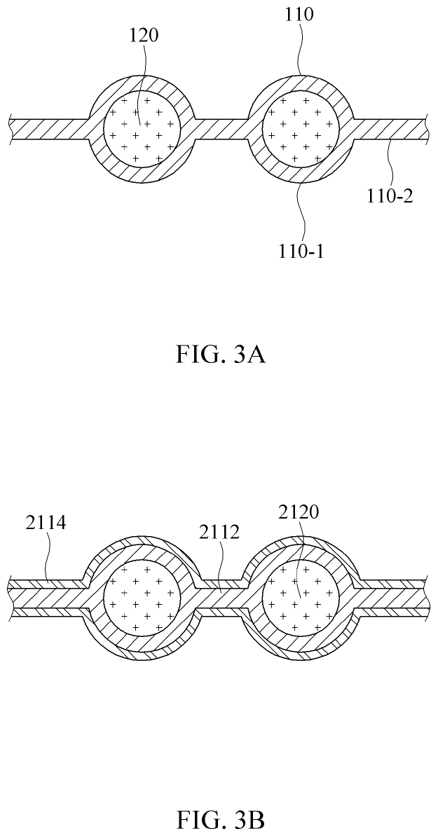

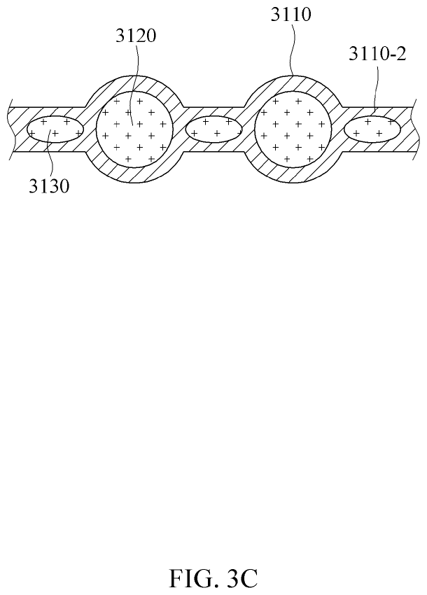

FIG. 1 is a perspective view of a fire extinguishing device 100 having a fire extinguishing agent 120 and a fire extinguishing capsule formed in a film shape, according to an embodiment, FIG. 2 is a perspective view of the fire extinguishing device 100 having the fire extinguishing agent 120 and a fire extinguishing capsule that is formed in a pouch shape to include a target object inside, according to an embodiment, and FIGS. 3A to 3C are cross-sectional views of a capsule 110-1 and skirt 110-2 portions of the fire extinguishing device 100 having the fire extinguishing agent 120 and a fire extinguishing capsule, according to an embodiment.

Referring to FIG. 3A, the fire extinguishing device 100 having the fire extinguishing agent 120 and a fire extinguishing capsule may include a base portion 110 and the fire extinguishing agent 120.

The base portion 110 may have an internal space in which the fire extinguishing agent 120 may be placed. The base portion 110 storing the fire extinguishing agent 120 inside may be a separate fire extinguishing device 100 or a fire extinguishing device 100 in the form of a sheet, in which a plurality of base portions 110 are connected by the skirt 110-2.

The fire extinguishing agent 120 may include a fire extinguishing substance and a neutralizing substance. The fire extinguishing substance may be a substance that may extinguish a flame of the target object (hereinafter, a battery B) when the battery B ignites, and the neutralizing substance may be a substance that may neutralize acid gas generated when the battery B ignites.

The fire extinguishing substance may desirably vaporize at a determined temperature, and due to vaporization pressure of the fire extinguishing substance, the base portion 110 may expand and be destroyed. As the base portion 110 is destroyed, the fire extinguishing agent 120, that is, the fire extinguishing substance and the neutralizing substance, may be dispersed toward the battery B.

To neutralize the acid gas described above, the neutralizing substance may be a substance having alkaline properties.

Specifically, when ignition occurs in a lithium-ion battery, the acid gas may be hydrogen fluoride, that is, hydrofluoric acid gas. Since hydrofluoric acid gas is extremely harmful to the human body and has a small molecular weight and thus a fast diffusion rate, the neutralizing substance may desirably be dispersed from the top of the battery B toward the battery B and desirably be composed of a substance that easily decontaminates hydrofluoric acid gas.

For example, the neutralizing substance may be various calcium compounds. However, embodiments are not limited thereto.

The base portion 110 may have a single space or a plurality of partitioned spaces inside. When the base portion 110 has a single space inside, the neutralizing substance and the fire extinguishing substance may be provided mixed with each other. When the base portion 110 has a plurality of partitioned spaces inside, the neutralizing substance and the fire extinguishing substance may be provided separated from each other.

In an embodiment in which a plurality of partitioned spaces is provided in the base portion 110, a partition wall may be formed in the internal space of the base portion 110 and the neutralizing substance and the fire extinguishing substance may be separately provided in two spaces partitioned by the partition wall.

In another embodiment in which a plurality of partitioned spaces is provided in the base portion 110, the base portion 110 may have a first capsule and a second capsule, wherein the first capsule may be placed in a space formed inside the second capsule.

Specifically, the base portion 110 may be in the form of a double capsule in which the second capsule surrounds the first capsule. An internal space (a first space) may be formed inside the first capsule, and the fire extinguishing substance may be provided in the first space. Similarly, an internal space (a second space) may be formed inside the second capsule and the neutralizing substance may be provided in the second space along with the first capsule.

The thickness or composition of the first capsule and the second capsule may be identical, or desirably, the second capsule may have superior heat resistance than the first capsule.

When the fire extinguishing substance inside the first capsule vaporizes due to ignition of the battery B, the first capsule may expand due to the vaporization pressure of the fire extinguishing substance, and similarly, the second capsule may also expand due to the expansion of the first capsule.

When the expansion of the first capsule and the second capsule reaches a threshold, the first and second capsules may be almost simultaneously destroyed and, accordingly, the fire extinguishing substance provided in the first capsule and the neutralizing substance provided in the second capsule may be simultaneously dispersed.

Since the neutralizing substance is placed outside the first capsule, when the first capsule expands and is destroyed, the neutralizing substance may be easily dispersed by fracture pressure of the first capsule.

The base portion 110 may be formed in a film shape that composes a two-dimensional plane and may be manufactured in various shapes including a pouch shape, band shape, tape shape, cylindrical shape, shield shape, and the like that may be made from such a film. With respect to this, FIG. 1 shows a fire extinguishing device 100 having a film shape in which the base portion 110 is formed in a film shape, and FIG. 2 shows a fire extinguishing device 1100 in which the base portion 110 is formed in a pouch shape.

As shown in FIG. 2, the fire extinguishing device 1100 may be placed in contact with the target object (the battery B).

Referring to FIG. 3A again, the base portion 110 may include a plurality of capsules 110-1 in which a space is provided and a skirt 110-2 connecting the plurality of capsules 110-1. The capsules 110-1 may be arranged spaced apart from each other on a two-dimensional plane and the skirt 110-2 may be formed between the arranged capsules 110-1.

The skirt 110-2 may connect the capsules 110-1 when the capsules 110-1 are arranged spaced apart from each other or may be omitted when the capsules 110-1 are arranged adjacent to each other.

The base portion 110 including the capsules 110-1 and the skirt 110-2 may be placed in contact with the battery B. More specifically, the base portion 110 formed in a film shape may be secondarily formed in a shape surrounding the battery B according to the external shape of the battery B and a portion of the capsules 110-1 placed protruding from the skirt 110-2 may be in contact with the outer surface of the battery B.

The capsules 110-1 may have an internal space in various shapes including a spherical shape, columnar shape, oval shape, and the like, and the fire extinguishing agent 120 may be filled in the internal space. When heat is generated in the battery B, the fire extinguishing agent 120 may vaporize due to the heat and the capsules 110-1 may expand due to the vaporization pressure of the fire extinguishing agent 120. Desirably, the capsules 110-1 may be formed of soft silicone and polymer so that each of the capsules 110-1 may expand to about 10 times the initial volume of each of the capsules 110-1.

For example, the base portion 110 may be formed of a composite material of silicone and polymer to allow expansion or may be a laminate in which polymer is coated with silicone.

In addition, when the battery B (the target object) ignites, the fire extinguishing agent 120 may vaporize due to the heat, the capsules 110-1 may be destroyed due to the vaporization pressure of the fire extinguishing agent 120, and as the capsules 110-1 are destroyed, the fire extinguishing agent 120 may be supplied toward the battery B to extinguish a flame generated in the battery B.

The fire extinguishing agent 120 may desirably be in powder form and may vaporize at a temperature of 100 degrees Celsius or higher.

The fire extinguishing agent 120 of a plurality of types may be provided in the capsules 110-1 and an expansion agent that may expand the capsules 110-1 may also be provided in the capsules 110-1 along with the fire extinguishing agent 120. For example, the interior of the capsules 110-1 may be partitioned into a plurality of spaces and the fire extinguishing agent 120, the expansion agent, or an additional fire extinguishing agent may be separately provided in the spaces.

Referring to FIGS. 1 and 3A again, the base portion 110 may be formed in a form in which the capsules 110-1 protrude from the skirt 110-2 that is flat.

Due to the flat skirt 110-2 and the protruding capsules 110-1, a space may be formed between the battery B and the base portion 110. Specifically, an outer portion of the capsules 110-1 formed protruding from the skirt 110-2 may be in contact with the outer surface of the battery B, and a space defined by one of the capsules 110-1, another of the capsules 110-1 spaced apart from the one, the skirt 110-2 connecting the two of the capsules 110-1, and a surface of the battery B may be formed. That is, the skirt 110-2 and the battery B may be spaced apart from each other by the capsules 110-1 and a space may be formed between the skirt 110-2 and the battery B. Cooling fluid such as coolant or air may flow in the space and cool the battery B.

FIG. 3B shows a cross-section of a base portion formed of multiple layers according to another embodiment.

Referring to FIG. 3B, the capsules 110-1 of the base portion may be formed of a polymer layer 2112 and a silicone layer 2114. The polymer layer 2112 may be formed to surround the fire extinguishing agent 2120, and the silicone layer 2114 may be coated on the outer surface of the polymer layer 2112.

Similar to the capsules 110-1, the skirt 110-2 may be formed of the polymer layer 2112 and the silicone layer 2114, wherein the polymer layer 2112 may be covered with the silicone layer 2114. In still another embodiment, the skirt 110-2 may be formed only of silicone.

FIG. 3C shows a cross-section of a base portion according to still another embodiment.

Referring to FIG. 3C, a predetermined expansion space may be formed in a skirt 3110-2 of a base portion 3110. When the battery B generates heat or ignites and thus the skirt 3110-2 reaches a determined temperature, the expansion space may expand, and the expanded skirt 3110-2 may come into close contact with the outer surface of the battery B to block external air (e.g., oxygen).

A fire extinguishing agent 3120, an expansion agent 3130, or an additional fire extinguishing agent that vaporizes or expands at a determined temperature may be provided in the expansion space.

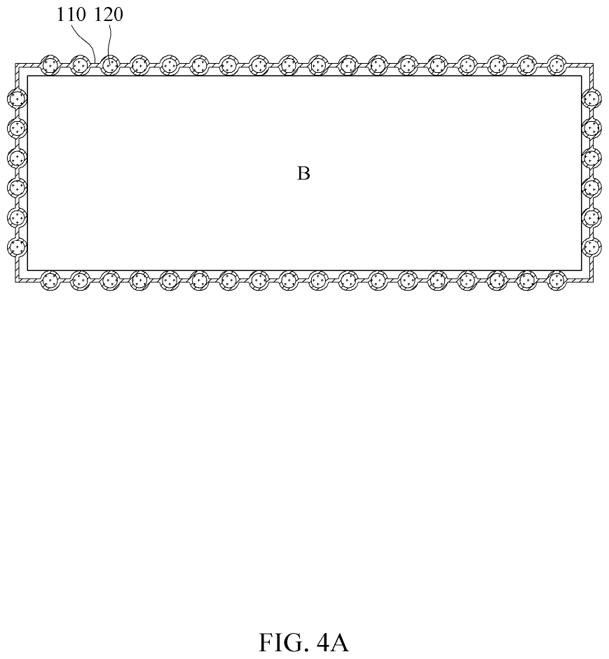

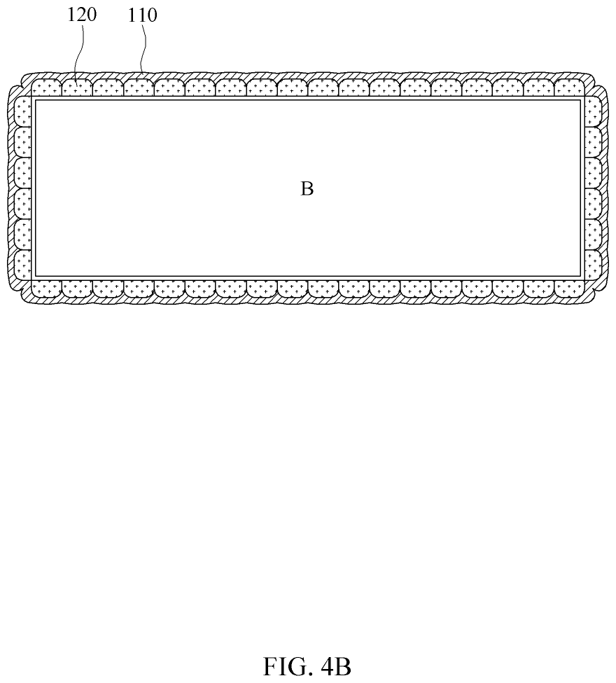

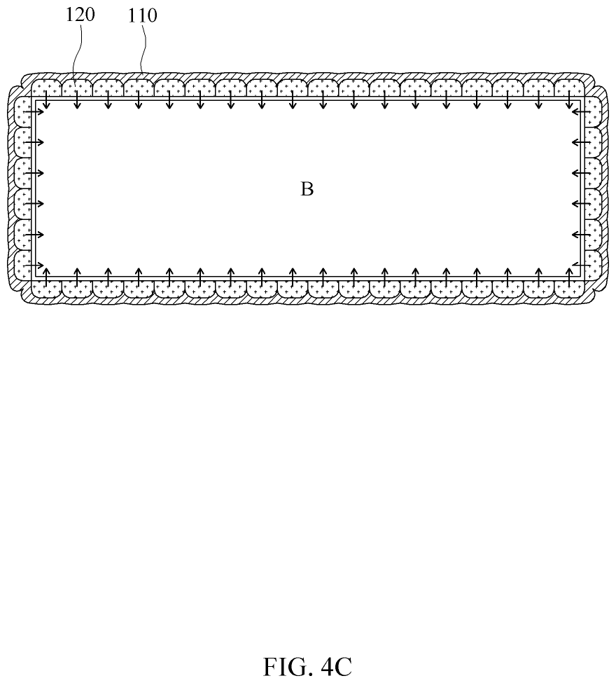

FIGS. 4A to 4C are diagrams illustrating changes in a fire extinguishing device 100 having a fire extinguishing agent 120 and a fire extinguishing capsule due to ignition or heat generation of the battery B.

Specifically, FIG. 4A is a cross-sectional view of the fire extinguishing device 100 having the fire extinguishing agent 120 and a fire extinguishing capsule, which is placed to surround the battery B, FIG. 4B is a cross-sectional view illustrating the way the base portion 110 is transformed due to a temperature rise of the battery B and seals the battery B, and FIG. 4C is a cross-sectional view illustrating the way the capsules 110-1 of the base portion 110 are destroyed due to ignition of the battery B and the fire extinguishing agent 120 in the capsules 110-1 is ejected toward the battery B.

Referring to FIG. 4A, the fire extinguishing device 100 may be placed to surround the battery B. The capsules 110-1 may be placed to be in contact with the outer surface of the battery B, and the skirt 110-2 may be spaced apart from the outer surface of the battery B to form a space therebetween. Cooling fluid for cooling the battery B may flow in the space.

Referring to FIG. 4B, when heat is generated in the battery B above a determined temperature, the fire extinguishing agent 120 may vaporize and expand, and according to the vaporization of the fire extinguishing agent 120, the base portion 110 may expand and thus the space between the battery B and the base portion 110 may be filled. That is, as the base portion 110 expands, the contact area of the base portion 110 with the battery B may increase and the base portion 110 may block the battery B from external air, thereby suppressing the ignition of the battery B to some extent.

Alternatively, when the fire extinguishing device 100 according to the present disclosure is installed in various devices other than the battery B, the expanded base portion 110 may seal a target object (e.g., the battery B) so that oxygen, which is a gas that supports combustion, may be blocked in the case of ignition and, accordingly, a primary fire extinguishing effect may be obtained.

To improve such a sealing effect, the base unit 110 may include a trigger member. When a local heat generation occurs and the capsules 110-1 expand at the location of the heat generation, the trigger member may expand all of the capsules 110-1 in the base portion 110 to perform quick sealing.

For example, the trigger member may be a sensor, a temperature control device, and the like. When the sensor detects abnormal overheating or a fire, the trigger member may heat all of the capsules 110-1 simultaneously using the temperature control device so that the capsules 110-1 may expand and the battery B may be sealed.

Referring to FIG. 4C, when the battery B explodes or ignites, the base portion 110 may be destroyed and the fire extinguishing agent 120 inside the base portion 110 may be ejected toward the battery B.

The fire extinguishing device 100 may further include a dispersing portion. When the base portion 110 is destroyed due to the ignition of the battery B, the dispersing portion may easily disperse a neutralizing substance around the battery B. The dispersing portion may be a diffusing agent that helps expansion or fracture of a first capsule and a second capsule, a blower that supplies wind, and the like.

In addition, the fire extinguishing device 100 may further include a fracture portion, an ignition detection portion, and a controller.

The ignition detection portion may detect the ignition of the battery B and may be, for example, a gas sensor, a temperature sensor, an optical sensor, or the like. Upon detecting the ignition of the battery B, the ignition detection portion may transfer a fire outbreak signal to the controller, and the controller that received the fire outbreak signal may transfer an instruction to destroy the base unit 110 to the fracture portion. The fracture portion may destroy the base portion 110 so that the fire extinguishing agent 120 may be dispersed toward the battery B.

The controller may operate the dispersing portion at the same time, and the diffusion properties of the fire extinguishing agent 120 may thus be improved.

According to the fire extinguishing device 100 having the fire extinguishing agent 120 and a fire extinguishing capsule described above, the fire extinguishing device 100 may neutralize hydrofluoric acid gas generated in the event of a fire, quickly extinguish a battery fire, and be easily installed in a desired location.

In addition, the fire extinguishing device 100 may automatically extinguish a battery fire and quickly disperse a neutralizing agent to prevent hydrofluoric acid gas from spreading into the air.

According to the fire extinguishing device 100 having the fire extinguishing agent 120 and a fire extinguishing capsule implemented according to the description above, the fire extinguishing capsule may expand in the event of a battery fire to seal the battery B and thus block the battery B from the air, thereby suppressing and extinguishing the fire.

In addition, as the fire extinguishing capsule expands, the space between the battery B and the fire extinguishing device 100 may be blocked and, as a result, the fire extinguishing capsule may be destroyed and the fire extinguishing agent 120 may be intensively supplied to the battery B and not discharged to the outside.

In addition, a space may be formed between the fire extinguishing capsule and the battery B to provide a space for cooling fluid to flow, the fire extinguishing device 100 that is flexible enough to be installed on batteries of various shapes may be provided, and sealing property may be improved by simultaneously expanding all fire extinguishing capsules in the event of the ignition of the battery B.

The fire extinguishing device 100 having the fire extinguishing agent 120 and a fire extinguishing capsule described above is not limited to the configurations and methods of the embodiments described above. Various modifications may be made to the embodiments described above and all or part of the embodiments may be selectively combined for a configuration.

As described above, the embodiment has been described with reference to specific matters such as specific components and limited embodiments and drawings, but these are provided to help the overall understanding. Also, the present disclosure is not limited to the above-described embodiments, and various alterations and modifications may be made by one of ordinary skill in the art to which the present disclosure pertains. For example, suitable results may be achieved if the described techniques are performed in a different order and/or if components in a described system, architecture, device, or circuit are combined in a different manner and/or replaced or supplemented by other components or their equivalents. Accordingly, the scope of the present disclosure is defined not by the detailed description, but by the claims and their equivalents, and all variations within the scope of the claims and their equivalents are to be construed as being included in the disclosure.

What is claimed is:

1. A fire extinguishing device having a fire extinguishing agent and a fire extinguishing capsule, the fire extinguishing device comprising:
a base portion having an internal space in a form of a capsule; and
a fire extinguishing agent located inside the base portion and configured to extinguish a flame,
wherein the base portion is formed to be in contact with a target object,
wherein the fire extinguishing agent vaporizes at a determined temperature or higher according to heat generation or ignition of the base portion,
wherein the base portion is formed by mixing polymer and silicone or comprises a polymer layer and a silicone layer configured to coat an outer surface of the polymer layer, and is configured to expand and rupture at the determined temperature due to vaporization of the fire extinguishing agent,
wherein a contact area between the base portion and the target object increases as the base portion expands, and
wherein the base portion is configured to, in a case of a fire or explosion of the target object, be destroyed together and the fire extinguishing agent is dispersed in a direction of the target object.

2. The fire extinguishing device of claim 1,
wherein the base portion is formed in a cylindrical shape, pouch shape, pad shape, or tape shape,
wherein the base portion comprises:
a plurality of capsules; and
a skirt extending flat from the capsules and connecting the capsules, and
wherein the base portion is
formed in a plane film shape so that the plurality of capsules is arranged in a plane, and
configured to, when the target object reaches the determined temperature or higher due to external ignition or heat generation, expand due to the fire extinguishing agent and block the target object from air.

3. The fire extinguishing device of claim 2, wherein
the capsules protrude from the skirt that is formed flat, so that
the capsules are in contact with the target object,
the skirt is placed to be spaced apart from the target object, and
a space is formed between the target object and the skirt.

4. The fire extinguishing device of claim 2, wherein
a determined expansion space is formed inside the skirt and the fire extinguishing agent, an expansion agent, or an additional fire extinguishing agent that vaporizes or expands at the determined temperature is provided in the expansion space, or
an inside of the capsules is formed as a plurality of partitioned hollow portions and the fire extinguishing agent, the expansion agent, or the additional fire extinguishing agent is separately provided in each of the partitioned hollow portions, and
when the capsules or the skirt reaches the determined temperature due to ignition or heat generation of the target object, the fire extinguishing agent, the expansion agent, or the additional fire extinguishing agent vaporizes or expands and, accordingly, the capsules or the skirt expands to be in contact with the target object.

5. The fire extinguishing device of claim 2, wherein
the base portion comprises a trigger member configured to promote vaporization of the fire extinguishing agent, and
the trigger member is configured to, in a case of ignition or heat generation of the target object, expand the capsules simultaneously at the determined temperature or higher.

6. A fire extinguishing device having a fire extinguishing agent and a fire extinguishing capsule, the fire extinguishing device comprising:
a base portion comprising a space inside; and
a fire extinguishing agent,
wherein the fire extinguishing agent comprises:
a fire extinguishing substance configured to extinguish a target object in a case of ignition of the target object; and
a neutralizing substance configured to neutralize acid gas generated due to the ignition of the target object.

7. The fire extinguishing device of claim 6, wherein
the base portion comprises a partitioned space inside,
the fire extinguishing substance is provided in the partitioned space inside the base portion,
the neutralizing substance is provided in the partitioned space inside the base portion separately from the fire extinguishing substance,
the fire extinguishing substance vaporizes in the case of the ignition of the target object, the partitioned space inside the base portion in which the fire extinguishing substance is provided expands and is destroyed due to vaporization pressure of the fire extinguishing substance, the partitioned space inside the base portion in which the neutralizing substance is provided is destroyed together with the partitioned space inside the base portion in which the fire extinguishing substance is provided, and the fire extinguishing substance and the neutralizing substance are simultaneously dispersed, and
the neutralizing substance comprises an alkaline component or a calcium compound component.

8. The fire extinguishing device of claim 6, further comprising:
a fracture portion;
an ignition detection portion; and
a controller,
wherein the fracture portion is configured to destroy the base portion at a determined temperature or in a case of a flame,
wherein the ignition detection portion is configured to detect the ignition of the target object and transmit an ignition signal to the controller,
wherein the controller is configured to transmit a base portion destruction signal to the fracture portion, and
wherein the fracture portion is configured to destroy the base portion to disperse the fire extinguishing agent to the target object.
